(19) United States
(12) Patent Application Publication
(10) Pub. No.: US 2017/0224021 A1
(43) Pub. Date: Aug. 10, 2017

(54) FORMING METHOD FOR HEATING ELEMENT OF ELECTRONIC CIGARETTE AND MANUFACTURING METHOD FOR ATOMIZATION ASSEMBLY

(71) Applicant: HUIZHOU KIMREE TECHNOLOGY CO., LTD., HUIZHOU, GUANGDONG (CN)

(72) Inventor: Zhiyong XIANG, DONGGUAN, GUANGDONG (CN)

(73) Assignee: HUIZHOU KIMREE TECHNOLOGY CO., LTD., HUIZHOU, GUANGDONG (CN)

(21) Appl. No.: 15/502,049

(22) PCT Filed: Oct. 27, 2014
(86) PCT No.: PCT/CN2014/089608

§ 371 Date: Feb. 6, 2017

(51) Int. Cl. A24F 47/00; H01C 17/00; C25D 7/06; H05B 3/42; C25D 5/02

(52) U.S. Cl. CPC A24F 47/008; H05B 3/42; C25D 5/022; C25D 7/0607; H01C 17/00; H05B 2203/017; H05B 2203/021

(57) ABSTRACT

A forming method for a heating element of an electronic cigarette and a manufacturing method for an atomization assembly are provided, the forming method comprises coiling a heating wire into a heating coil, dividing the heating coil into sections including a plurality of heating sections and connecting sections; providing a deposition preventing layer on an external surface of the heating section; electroplating the heating coil, coating outer peripheral faces of all of the connecting sections of the heating coil with coatings having an electrical resistivity lower than that of the heating wire; removing the deposition preventing layer; and cutting the heating coil electroplated. The present application makes the manufacturing process of the heating element and the atomization assembly continues automatically, the production efficiency is improved, the resistance of the heating element or atomization assembly manufactured is more stable, and the product quality is higher.

### TECHNICAL FIELD

The present application relates to the technical field of smoking sets, and more particularly, relates to a forming method for a heating element of an electronic cigarette and a manufacturing method for an atomization assembly.

### BACKGROUND

A heating element of an electronic cigarette includes a heating section and a connecting section. Wherein a cooper wire is generally used as the connecting section, and the connecting section is configured to be electrically connected to a drive circuit, and further electrically connected to a power source via the drive circuit, or the connecting section is directly and electrically connected to the power source via the copper wire. The heating section is generally made from an alloying heating element with a high resistivity (such as a nichrome wire, iron-chromium-aluminum-alloy, constantan alloy, and the like). After energized, the heating section releases heat to atomize tobacco tar, and thus a smoking effect may be achieved. The connecting section of the heating element and the heating section thereof may be connected to each other using a welding or riveting process, which makes the manufacturing process of the heating element complicate. Besides, a resistance of the heating element which is batch manufactured using the welding or riveting process is unstable. Furthermore, a welding spot of the heating element manufactured by the welding or riveting process is prone to be oxidized, and a contact resistance at the welding joint is relative large.

In a new type of manufacturing process of the heating element, the heating section and the connecting section of the heating element are integrally made from a metal material. Then a coating is formed on the connecting section of the individual heating element by means of an electroplating process, in order to increase the structural strength of the connecting section and reduce the generated heat, such that the driving is facilitated, and the connecting section is convenient to be connected to the drive circuit via the coating. In this way, various defects caused by the welding process may be avoided. However, during the electroplating process of the individual heating element, the heating section is prone to be electroplated as well, and thus, the resistance of the heating element is unstable. Besides, when the individual heating element is electroplated using the electroplating process in the art, the efficient is low, the process is time-consuming, and is bad for the industrial production.

### BRIEF SUMMARY

One object of the present application is to provide a high-efficient forming method for a heating element of an electronic cigarette, aiming at the defects in the art described above.

Another object of the present application is to provide a high-efficient manufacturing method for an atomization assembly of the electronic cigarette.

In accordance with one aspect of the present application,

constructing a forming method for a heating element of an electronic cigarette, wherein, the method comprises the following steps:

A: coiling a heating wire made from metal material into a heating coil, and dividing the heating coil into sections; wherein the sections include a plurality of heating sections configured to atomize tobacco tar, and a plurality of connecting sections configured to be connected to a power source of the electronic cigarette; the plurality of heating sections are separated from each other with internals therebetween, and are further connected to each other through the plurality of connecting sections;

B: providing a deposition preventing layer on an external surface of the heating section to prevent the external surface of each heating section from being electroplated due to maloperation;

C: electroplating the heating coil, and simultaneously coating outer peripheral faces of all of the connecting sections of the heating coil with coatings having an electrical resistivity lower than that of the heating wire;

D: removing the deposition preventing layer on the external surface of the heating section; and

E: cutting the heating coil electroplated, and obtaining a heating element cell during each cutting; wherein each the heating element cell includes one heating element and two connecting sections arranged at both ends of the heating section.

In the forming method of the present application, wherein the step B specifically includes the step: painting a layer of deposition preventing paint on the external surface of the heating section to form the deposition preventing layer; and

the step D specifically includes the step: peeling off the deposition preventing paint.

In the forming method of the present application, wherein the step B specifically includes the step: wrapping a layer of rubber on the external surface of the heating section by a wire and cable extruder to form the deposition preventing layer; and

the step D specifically includes the step: removing the rubber by a cable peeling machine.

In the forming method of the present application, wherein the step B specifically includes the step: clamping and sealing up the external surface of the heating section by a clamp to form the deposition preventing layer; and

the step D specifically includes the step: removing the clamp from the external surface of the heating section.

In the forming method of the present application, the methods for painting a layer of the deposition preventing paint on the external surface of the heating section include brushing, spraying, roller coating or dip coating.

In the forming method of the present application, wherein the deposition preventing paint is made from resins, or a mixture of polymers, additives and solvents.

In the forming method of the present application, wherein the step B specifically includes the step:

twining the heating coil on an insulating square frame in such a way that the plurality of heating sections and connecting sections are located on different surfaces of the square frame respectively;

uniformly sealing up and blocking the surfaces of the square frame on which the heating sections located by a pressing plate or a clamp to form the deposition preventing layer; and

the step D specifically includes the step:

removing the pressing plate or the clamp.

In the forming method of the present application, wherein the metal material includes any one of nickel-chrome alloy, nickel-chrome-iron alloy, nickel-chrome-aluminum alloy and constantan alloy.

In the forming method of the present application, wherein the coatings are the coatings made of materials selecting from one or more of gold, silver, copper, zinc and tin.

In the forming method of the present application, wherein the electrical resistivity of the coatings is less than 2.5×10⁻⁸ Ωm.

In another aspect, this present application further provides a manufacturing method for an atomization assembly, wherein the atomization assembly comprises a heating element configured to atomize tobacco tar, and a tar guiding wick configured to guide tobacco tar to the heating element for atomization; wherein the manufacturing method comprises the following steps:

S1: coiling a heating wire made from metal material into a heating coil, and dividing the heating coil into sections; wherein the sections include a plurality of heating sections configured to atomize tobacco tar, and a plurality of connecting sections configured to be connected to a power source of the electronic cigarette; the plurality of heating sections are separated from each other with internals therebetween, and are further connected to each other through the plurality of connecting sections;

S2: electroplating the heating coil, and simultaneously coating outer peripheral faces of all the connecting sections of the heating coil with coatings having an electrical resistivity lower than that of the heating wire;

S3: coiling the heating sections at a free end of the heating coil coated with the coatings on a tar guiding wick, in such a way that the heating sections are spirally twined on the tar guiding wick;

S4: cutting the connecting sections at one end of the heating sections twined on the tar guiding wick, in such a way that two ends of each heating section twined on the tar guiding wick are both connected to the connecting sections.

In the manufacturing method of the present application, wherein the step S3 specifically includes the step:

the tar guiding wick is a tar guiding wick coil which is sleeved at a first fixing part of a first bracket; wherein the first fixing part is rotatable relative to the first bracket under an action of an external force, and a free end of the tar guiding wick moves towards a first preset direction under an applied force of a traction device, in such a way that the heating section twined on the tar guiding wick moves towards the first preset direction along with the tar guiding wick;

after the step S4, a step is further included:

cutting the tar guiding wick at a first preset position in the first preset direction, in such a way that the heating section located at the end of the tar guiding wick falls down together with the tar guiding wick on which the heating section is twined, thereby forming the atomization assembly.

In the manufacturing method of the present application, wherein in the step S3, a first rotation device and a second rotation device are arranged between the first fixing part and the first preset position; a first tar guiding wick clamping assembly is arranged on the first rotation device, and a second tar guiding wick clamping assembly is arranged on the second rotation device; a heating wire clamping device is arranged at an end of the second rotation device oriented towards the first rotation device, in such a way that, after a connecting section at the free end of the heating coil has been clamped by the heating wire clamping device, the heating wire clamping device rotates along with the first rotation device and the second rotation device, and further moves in the first preset direction, in such a way that the heating section is spirally twined on the tar guiding wick.

In the manufacturing method of the present application, wherein in the step S3, a third tar guiding wick clamping assembly is arranged on one side of the first preset position opposite to the second rotation device, in such a way that when cutting the tar guiding wick, the tar guiding wick is clamped by the second tar guiding wick clamping assembly and the third tar guiding wick clamping assembly together; when the second tar guiding wick clamping assembly is released from the clamping on the tar guiding wick and moves along with the second rotation device in a direction opposite to the first preset direction, the third tar guiding wick clamping assembly clamps the free end of the tar guiding wick coil.

In the manufacturing method of the present application, wherein in the step S3, the first rotation device and the second rotation device are connected to a same power device by a transmission connection, in such a way that the first rotation device and the second rotation device are driven by the power device to rotate synchronously.

In the manufacturing method of the present application, wherein the traction device is a motor, and the motor is connected to the first rotation device and the second rotation device by a transmission connection; by driving the first rotation device and the second rotation device to move in the first preset direction, the tar guiding wick is conveyed towards the first preset direction.

In the manufacturing method of the present application, wherein a step S21 is further included between the steps S2 and S3:

sleeving the heating coil coated with coatings on a second fixing part of a second bracket, wherein the second fixing part is rotatable relative to the second bracket; the free end of the heating coil is conveyed towards a position between the first rotation device and the second rotation device by a second traction device.

In the manufacturing method of the present application, wherein a step is further included before the step S2: providing a deposition preventing layer on an external surface of the heating section to prevent the external surface of the heating section from being electroplated due to maloperation;

a step is further included after the step S2: removing the deposition preventing layer on the external surface of the heating section.

In another aspect, this present application further provides a manufacturing method for an atomization assembly, wherein the atomization assembly comprises a heating element configured to atomize tobacco tar, and a tar guiding wick configured to transform tobacco tar to the heating element for atomization; wherein, the manufacturing method comprises the following steps:

F1: coiling a heating wire made from metal material into a heating coil, and dividing the heating coil into sections; wherein the sections include a plurality of heating sections configured to atomize tobacco tar, and a plurality of connecting sections configured to be connected to a power source of the electronic cigarette; the plurality of heating sections are separated from each other with internals therebetween, and are further connected to each other through the plurality of the connecting sections;

F2: electroplating the heating coil, and simultaneously coating outer peripheral faces of all the connecting sections of the heating coil with coatings having an electrical resistivity lower than that of the heating wire;

F3: cutting the heating coil electroplated, and obtaining a heating element cell during each cutting; wherein each the heating element cell includes one heating element and two connecting sections arranged at both ends of the heating section;

F4: coiling the heating element cell on a tar guiding wick to make the heating section in a spiral shape;

F5: cutting the tar guiding wick coiled with the heating element cell to obtain a single atomization assembly.

The following advantages of the present application can be achieved: by coiling a heating wire into a heating coil, and dividing the heating coil into a plurality of heating sections configured to atomize tobacco tar and a plurality of connecting sections configured to be connected to a power source of the electronic cigarette, and then electroplating the connecting sections of the heating coil simultaneously, the manufacturing process of the heating element or the atomization assembly can be continued automatically, which improves the production efficiency and facilitates the industrial production. Besides, the heating wire is integrative, thus, various defects caused by the welding process may be avoided, the resistance of the heating element manufactured is more stable, and product quality is higher.

### BRIEF DESCRIPTION OF THE DRAWINGS

The present application will be further described with reference to the accompanying drawings and embodiments in the following, in the accompanying drawings:

FIG. 1 illustrates a schematic view of a heating wire having a deposition preventing layer according to a preferred embodiment of the present application;

FIG. 2 illustrates a schematic view of the heating wire after being electroplated according to a preferred embodiment of the present application, wherein the heating wire still has the deposition preventing layer coated thereon;

FIG. 3 illustrates a schematic view of the heating wire after being electroplated according to a preferred embodiment of the present application, wherein the deposition preventing layer is removed;

FIG. 4 illustrates a structural schematic view showing the principle of the uniformly electroplating of the heating wires by means of a square frame according to a preferred embodiment of the present application;

FIG. 5 illustrates a schematic view showing the principle of a manufacturing method of an atomization assembly with one cutting according to a preferred embodiment of the present application;

FIG. 6 is a partially enlarged view of X portion of FIG. 5;

FIG. 7 illustrates a schematic view showing the principle of a manufacturing method of an atomization assembly with one cutting according to a preferred embodiment of the present application;

FIG. 8 is partially enlarged view of Y portion of FIG. 7; and

FIG. 9 is a structural schematic view of the atomization assembly manufactured by the manufacturing method of the atomization assembly according to the present application.

### DETAILED DESCRIPTION OF THE PREFERRED EMBODIMENTS

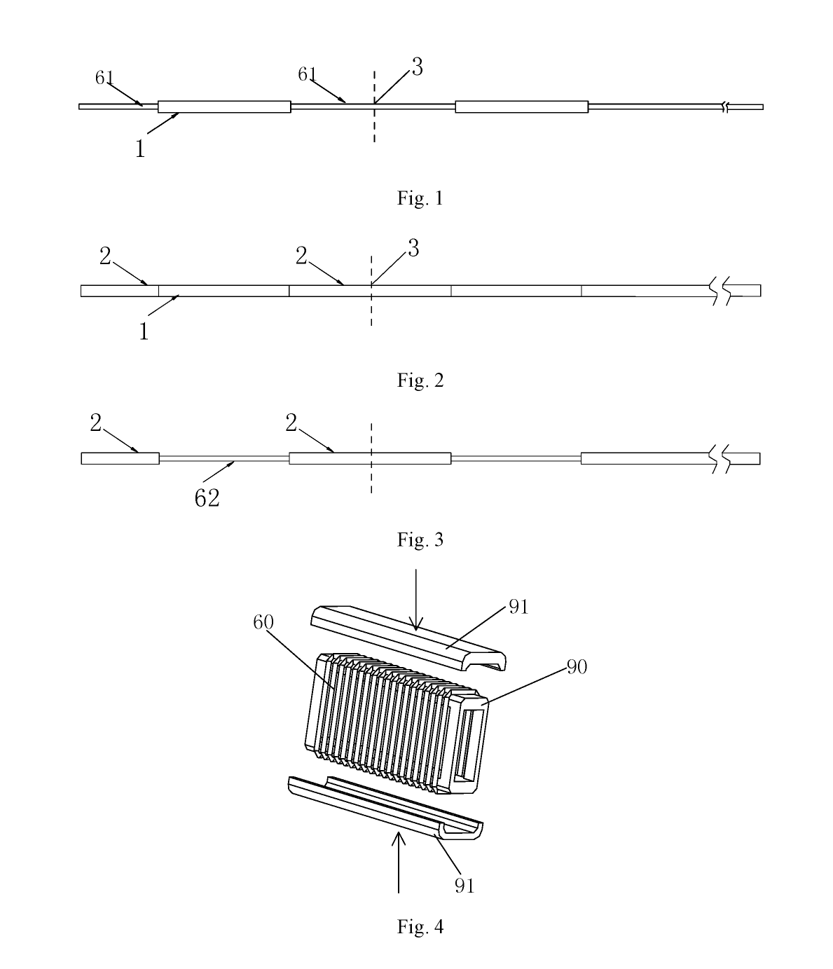

As shown in FIGS. 1-3 and 5-6, a forming method for a heating element of an electronic cigarette according to a preferred embodiment of the present application includes the following steps: S10, a heating wire 60 made from metal material is coiled into a heating coil, and the heating coil is further divided into sections. Wherein the sections include a plurality of heating sections 62 configured to atomize tobacco tar, and a plurality of connecting sections 61 configured to be connected to a power source of the electronic cigarette. The plurality of heating sections 62 are separated from each other with intervals therebetween, and are further connected to each other through the plurality of connecting sections 61. S20, a deposition preventing layer 1 is provided on an external surface of each heating section 62, in order to prevent the external surface of the heating section 62 from being electroplated due to maloperation. S30, the heating coil is electroplated, in such a way that outer peripheral faces of all of the connecting sections 61 of the heating coil are coated with coatings 2 having an electrical resistivity lower than that of the heating wire at the same time. S40, the deposition preventing layer 1 on the external surface of the heating section is removed. S50, after being electroplated, the heating coil is cut, and a heating element cell is therefore obtained during each cutting. In this case, every heating element cell includes one heating section and two connecting sections arranged at both ends of the heating section.

In the process described above, since the heating wire 60 is coiled into a heating coil, and the heating coil is further divided into sections, every stage of the manufacturing process of the heating element (including electroplating and cutting, etc.) can be performed continuously and automatically, which improves the production efficiency of the heating element. Besides, since the heating wire is integrative, that is to say, the heating sections 62 and the connecting sections 61 of the heating wire are integrally made from the same material, various defects caused by the welding process may be avoided, the resistance of the heating element manufactured is more stable, the conductivity is better and the product quality is higher.

Meanwhile, in the process described above, since a deposition preventing layer 1 is provided on the external surface of the heating section 62 before the electroplating to prevent the external surface of the heating section 62 from being electroplated due to the maloperation, it is possible to ensure that, in the next step of the electroplating process, the coatings 2 having an electrical resistivity lower than that of the heating wire can be accurately and quickly formed on the outer peripheral faces of all of the connecting sections 61 of the heating coil. In this way, it is possible to greatly improve the production efficiency of the heating element, and to reduce the rate of defective products meanwhile.

In the forming method for the heating element of the electronic cigarette described above, the metal material can be any one of nickel-chrome alloy, nickel-chrome-iron alloy, nickel-chrome-aluminum alloy and constantan alloy. For example, the metal material may be constantan 6J40, Cr20Ni80, and the like.

A shape of the metal material in all the embodiments of the present application is not limited here. For example, the shape of the metal material can be a filament, a sheet or a strip; or a shape of the cross section thereof is a circle, an ellipse, a polygon (including a triangle, a rectangle, etc.), or other geometrical shapes.

In the forming method for the heating element of the electronic cigarette described above, preferably, the electrical resistivity of the coating 2 is less than 2.5×10⁻⁸ Ωm, and the coatings 2 are the coatings made of materials selecting from one or more of gold, silver, copper, zinc and tin.

In the forming method for the heating element of the electronic cigarette described above, as shown in FIGS. 1-3, there are a lot of methods to arrange a deposition preventing layer 1 on the external surface of the heating section 62. For example, it is possible to use deposition preventing paint or a rubber as the deposition preventing layer 1, or the deposition preventing layer 1 is formed by using a clamp and the like.

In a specific embodiment, as shown in FIGS. 1-3, the step S20 above includes the step: a layer of deposition preventing paint is painted on the external surface of the heating section 62, to form the deposition preventing layer 1. The step S40 further includes the step: the deposition preventing layer 1 on the external surface of the heating section is peeled off. In this case, the methods for painting the layer of deposition preventing paint on the external surface of the heating section 62 include brushing, spraying, roller coating or dip coating. Preferably, the deposition preventing paint above is made from resins, or a mixture of polymers, additives and solvents. More preferably, the deposition preventing paint above is made from perchlorovinyl antiseptic varnish or PVC insulation coating.

In another specific embodiment, as shown in FIGS. 1-3, the step S20 above further includes the step: a layer of rubber is wrapped on the external surface of the heating section 62 by a wire and cable extruder, to form the deposition preventing layer 1. The step S40 further includes the step: the rubber is removed by a cable peeling machine. In other cases, a rubber belt or an adhesive tape may be wrapped on the external surface of the heating section 62, to form the deposition preventing layer 1. After the electroplating is completed, the rubber belt or the adhesive tape is removed from the external surface of the heating section 62. Or a melted wax preparation may be covered on the external surface of the heating section 62, to form the deposition preventing layer 1. After the electroplating is completed, the wax preparation is moved.

In a further specific embodiment, as shown in FIGS. 1-3, the step S20 above includes the step: a clamp is used to clamp and seal up the external surface of the heating section 62, to form the deposition preventing layer 1. The step S40 includes the step: the clamp is removed from the external surface of the heating section 62. When using this method to prepare a deposition preventing layer, it is possible to use two clamps to clamp the heating sections 62 arranged at both ends of the same connecting section 61 respectively to electroplate the connecting section 61 arranged therebetween, and the positions of the clamps are locked. After one connecting section 61 has been electroplated, the clamps are unlocked, and the heating wire is moved to a predetermined position, then the clamps are clamped again to electroplate a next connecting section 61. In this way, an automatic and continuous operation of the heating element can be realized, and the production efficiency is improved as a result.

In a further specific embodiment, as shown in FIG. 4 and simultaneously referring to FIGS. 1-3, the step S20 above includes the step: the heating coil is twined on a square frame 90 without any metal coated thereon, in such a way that the plurality of the heating sections 62 and the connecting sections 61 of the heating coil are located on three surfaces of the square frame 90 respectively. A pressing plate 91 or a clamp is used to uniformly seal up and block the surfaces of the square frame 90 on which the heating sections 62 are located, by which the deposition preventing layer 1 is formed. The step S40 includes the step: the pressing plate 91 or the clamp is removed. It is possible for the heating wire 60 to uniformly prevent from being electroplated by this method. In this way, the heating wire twined on the square frame 90 can be electroplated simultaneously, and the electroplating is more efficient.

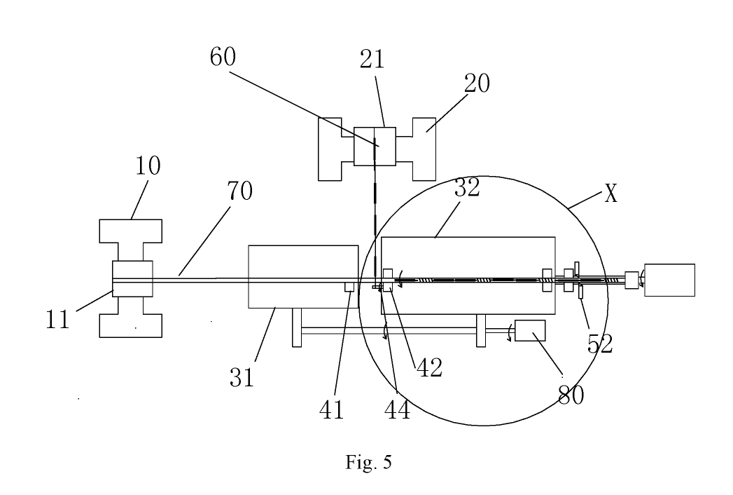

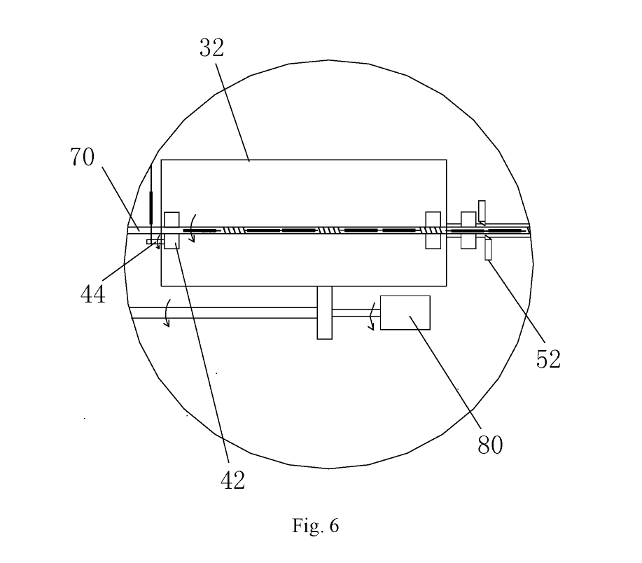

In addition, the present application further provides a manufacturing method for an atomization assembly, as shown in FIGS. 5-6, and meanwhile referring to FIGS. 1-3 and FIG. 9, the atomization assembly comprises a heating element for atomizing tobacco tar, and a tar guiding wick 70 configured to convey the tobacco tar to the heating element for the atomization of the tobacco tar. Wherein, the manufacturing method includes the following steps:

S11: a heating wire made from metal materials is coiled into a heating coil, and the heating coil is further divided into sections. Wherein the sections include a plurality of heating sections 62 configured to atomize tobacco tar, and a plurality of connecting sections 61 configured to be connected to a power source of the electronic cigarette. The plurality of heating sections 62 are separated from each other with intervals therebetween, and are further connected to each other through the plurality of connecting sections 61. The metal material can be any one of nickel-chrome alloy, nickel-chrome-iron alloy, nickel-chrome-alufer alloy and constantan alloy. For example, the metal material is constantan 6J40, Cr20Ni80, and the like.

S21: the heating coil is electroplated, in such a way that outer peripheral faces of all of the connecting sections 61 of the heating coil are coated with coatings 2 having an electrical resistivity lower than that of the heating wire simultaneously. Preferably, the electrical resistivity of the coating 2 is less than 2.5×10⁻⁸ Ωm, and the coatings 2 are the coatings made of materials selecting from one or more of gold, silver, copper, zinc and tin.

S31: a heating section 62 coated with the coatings 2 and at a free end of the heating coil is coiled on the tar guiding wick 70, in such a way that the heating section 62 is spirally twined on the tar guiding wick 70.

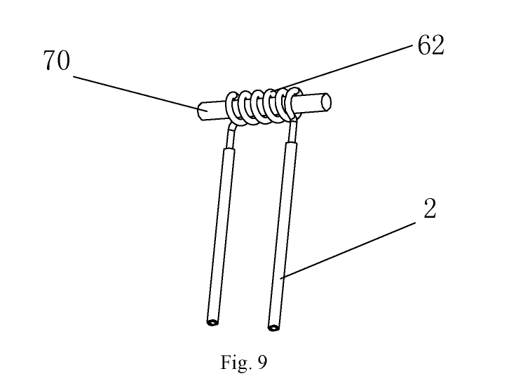

S41: the connecting section 61 at one end of the heating section 62 twined on the tar guiding wick 70 is cut. In this case, two ends of each of the heating section 62 twined on the tar guiding wick 70 are both connected to a connecting section 61. A cutting point 3 is shown in FIGS. 1-2, and thus an atomization assembly as shown in FIG. 9 is obtained.

In the manufacturing method for the atomization assembly described above, since the heating wire is coiled as a heating coil and the heating coil is further divided into sections, every stage of the manufacturing process of the atomization assembly (including electroplating and cutting, etc.) can be performed continuously and automatically, which improves the production efficiency of the atomization assembly. Besides, since the heating wire is integrative, that is to say, the heating sections 62 and the connecting sections 61 of the heating wire are integrally made from the same material, various defects caused by the welding process may be avoided, the resistance of the heating element manufactured is more stable, the conductivity is better, and the product quality is higher.

Meanwhile, in the manufacturing method for the atomization assembly above, since the heating section 62 of the heating wire is coiled on the tar guiding wick 70 at first, and then is cut, therefore, it only needs to cut once in the whole process. In this way, the process is simplified and the production efficiency is thereby improved.

In the step S31 above, the heating section 62 at the free end of the heating coil refers to the heating section 62 located at the end of the whole heating coil. After every completion of the step S41, that is to say, after a new heating section 62 is formed at the free end, the new heating section 62 is coiled again.

In the step S41 above, as shown in FIGS. 5-6, a second cutting assembly 52 is used to perform a one-time cutting to the heating wire and the tar guiding wick.

In a particular embodiment, as shown in FIGS. 5-6, and meanwhile referring to FIGS. 1-3, the step S31 above specifically includes the step: the tar guiding wick 70 is coiled into a tar guiding wick 70 coil sleeved on a first fixing part 11 of a first bracket 10, and the first fixing part 11 is rotatable relative to the first bracket 10 under an action of an external force. A free end of the tar guiding wick 70 moves towards a first preset direction under an applied force of a traction device, in such a way that the heating section 62 twined on the tar guiding wick 70 moves towards the first preset direction along with the tar guiding wick 70. After the step S41, a step is further included the step: cutting the tar guiding wick 70 at a first preset position in the first preset direction, in such a way that the heating section 62 located at the end of the tar guiding wick 70 falls down together with the tar guiding wick 70 on which the heating section 62 is twined, thereby forming an atomization assembly. By using the tar guiding wick 70 coil and the heating coil at the same time, it is possible to continue the coiling process of the tar guiding wick 70 directly after the heating wire has been electroplated. In this way, the whole production process of the atomization assembly can be performed automatically, and the production efficiency can be improved.

Furthermore, as shown in FIGS. 5-6, and referring to FIGS. 1-3, a first rotation device 31 and a second rotation device 32 are arranged between the first fixing part 11 and the first preset position. A first tar guiding wick clamping assembly 41 is arranged on the first rotation device 31, and a second tar guiding wick clamping assembly 42 is arranged on the second rotation device 32. A heating wire clamping device 44 is arranged at an end of the second rotation device 32 oriented towards the first rotation device 31. In this way, after a connecting section 61 at the free end of the heating coil has been clamped by the heating wire clamping device 44, the heating wire clamping device rotates along with the first rotation device 31 and the second rotation device 32, and further moves in the first preset direction. Thus, the heating section 62 is spirally twined on the tar guiding wick 70, and it is possible to realize a continuous and automatic process of coiling, and to improve the production efficiency.

Further, as shown in FIGS. 5-6, and referring to FIGS. 1-3, a third tar guiding wick clamping assembly 43 is further arranged on one side of the first preset position opposite to the second rotation device 32, in such a way that when cutting the tar guiding wick 70, the tar guiding wick 70 is clamped by the second tar guiding wick clamping assembly 42 and the third tar guiding wick clamping assembly 43 together. When the second tar guiding wick clamping assembly 42 is released from the tar guiding wick 70 and moves along with the second rotation device 32 in a direction opposite to the first preset direction, the third tar guiding wick clamping assembly 43 clamps the free end of the tar guiding wick coil, in order to cut the tar guiding wick 70 and the heating wire 60 fast and accurately, and thus an atomization assembly is obtained.

In the embodiment above, preferably, as shown in FIG. 5 and FIG. 6, the first rotation device 31 and the second rotation device 32 are connected to a same power device by a transmission connection, in such a way that the first rotation device 31 and the second rotation device 32 are driven by the power device to rotate synchronously in a direction indicated by the arrows in FIG. 5 and FIG. 6. In this way, the heating section 62 of the heating wire 60 may be twined on the tar guiding wick 70 in form of a standard spiral, to ensure the yield and consistency of products of the atomization assembly.

In the above embodiment, as shown in FIG. 5 and FIG. 6, preferably, the traction device is a motor 80, and the motor 80 is connected to the first rotation device 31 and the second rotation device 32 by a transmission connection. By driving the first rotation device 31 and the second rotation device 32 to move in the first preset direction, it is possible to convey the tar guiding wick 70 towards the first preset direction.

Further, as shown in FIG. 5 and FIG. 6, a step is further included between the steps S21 and S31: the heating coil coated with coatings 2 is sleeved on a second fixing part 21 of a second bracket 20, and the second fixing part is rotatable relative to the second bracket 20. The free end of the heating coil is conveyed towards a position between the first rotation device 31 and the second rotation device 32 by a second traction device.

In a further particular embodiment, as shown in FIGS. 5-6, and referring to FIGS. 1-3, a step is further included before the step S21 of the above manufacturing method for the atomization assembly: a deposition preventing layer 1 is provided on the external surface of the heating section 62, in order to prevent the external surface of the heating sections 62 from being electroplated due to the maloperation. After the step S21, the method further includes the step: the deposition preventing layer 1 on the external surface of the heating sections 62 is removed. In this case, the methods for forming the deposition preventing layer 1 and removing deposition preventing layer 1 can refer to the related embodiments of the forming method for the heating element of the electronic cigarette described above, and will not be explained any more here. By forming a deposition preventing layer 1 on the external surface of the heating section 62 before electroplating prevent the external surface of the heating section 62 from being electroplated due to the maloperation, it is possible to ensure that, the coatings 2 having an electrical resistivity lower than that of the heating wire can be accurately and quickly formed on the outer peripheral faces of all of the connecting sections 61 of the heating coil. In this way, it is possible to greatly improve the production efficiency of the atomization assembly, and to reduce the rate of defective products meanwhile.

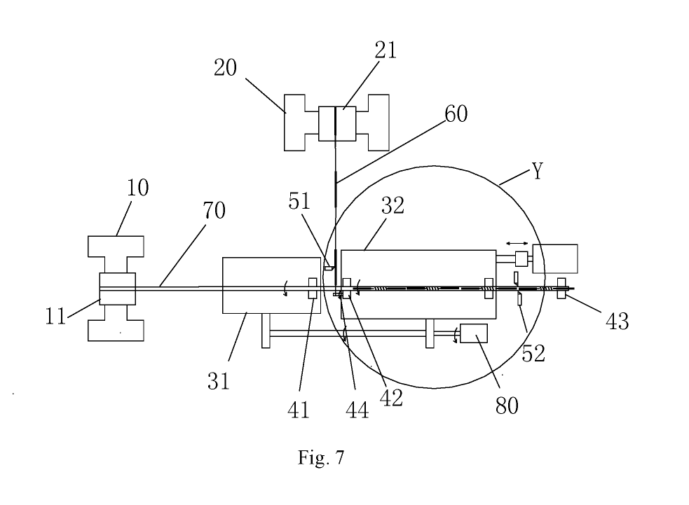

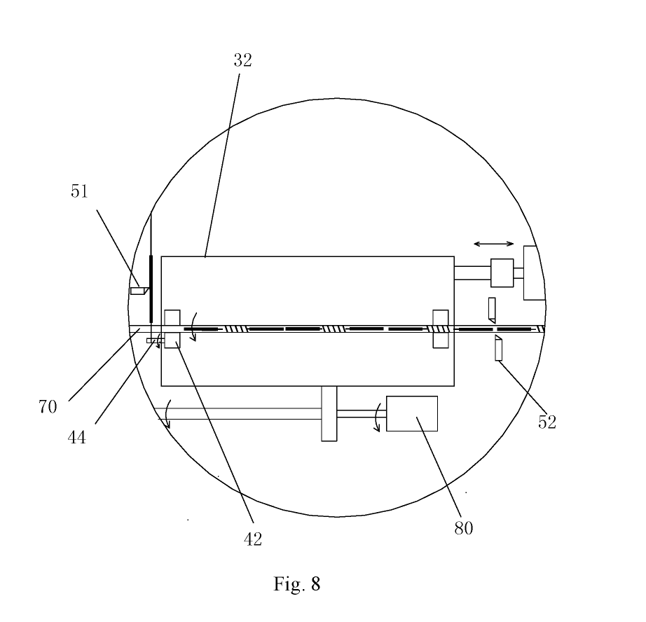

In addition, the present application further provides a further manufacturing method for an atomization assembly. As shown in FIGS. 7-8, and referring to FIGS. 1-3 and FIG. 9, the atomization assembly comprises a heating element for atomizing tobacco tar, and a tar guiding wick 70 configured to guide the tobacco tar to the heating element for atomization. Wherein, the manufacturing method comprises the following steps:

F10: a heating element made from metal material is coiled into a heating coil, and the heating coil is further divided into sections. Wherein the sections include a plurality of heating sections configured to atomize tobacco tar, and a plurality of heating sections configured to be connected to a power source of the electronic cigarette. The plurality of heating sections 62 are separated from each other with intervals therebetween, and are further connected to each other through the plurality of connecting sections 61. The metal material can be any one of nickel-chrome alloy, nickel-chrome-iron alloy, nickel-chrome-aluminum alloy and constantan alloy. For example, the metal material may be constantan 6J40, Cr20Ni80, and the like.

F20: the heating coil is electroplated, in such a way that outer peripheral faces of all of the connecting sections 61 of the heating coil are coated with coatings having an electrical resistivity lower than that of the heating wire simultaneously. Preferably, the electrical resistivity of the coating is less than 2.5×10⁻⁸ Ωm, and the coatings 2 are the coatings made of materials selecting from one or more of gold, silver, copper, zinc and tin.

F30: after being electroplated, the heating coil is cut, and a heating element cell is therefore obtained during each cutting. In this case, every heating element cell includes one heating section 62 and two connecting sections 61 arranged at both ends of the heating section 62. Wherein, the heating coil is cut with a first cutting assembly 51 shown in FIGS. 7-8.

F40: the heating element cell is coiled on a tar guiding wick 70, making the heating section 62 in a spiral shape.

F50: the tar guiding wick 70 coiled with the heating element cell is cut, in order to obtain a single atomization assembly. In this case, the tar guiding wick 70 is cut by a second cutting assembly 52 as shown in FIGS. 7-8.

In the manufacturing method for the atomization assembly described above, since the heating wire is coiled as a heating coil and the heating coil is further divided into sections, every stage of the manufacturing process of the atomization assembly (including electroplating and cutting, etc.) can be performed continuously and automatically, which improves the production efficiency of the atomization assembly. Besides, since the heating wire is integrative, that is to say, the heating sections 62 and the connecting sections 61 of the heating wire are integrally made from the same material, various defects caused by the welding process may be avoided, the resistance of the heating element manufactured is more stable, the conductivity is better, and the product quality is higher.

Meanwhile, in the above manufacturing method for the atomization assembly, the heating coil electroplated is cut at first, and a heating element cell is obtained during each cutting. Then, the heating section 62 of the heating element cell is coiled on the tar guiding wick 70. After that, the tar guiding wick 70 is cut alone in order to obtain a single atomization assembly. The whole process needs to be cut twice. Compared with the previous embodiment of the manufacturing method for the atomization assembly, the method in the present application involves one more cutting process, however, the entire process can still be fully automated, and the production efficiency can still be greatly improved.

It should be understand that in the inspiration of the present application, those skilled in the art may make many modifications, without going beyond the purpose and the scope the claims intend to protect of the present application; all these belong to the protection of the present application.

What is claimed is:

1. A forming method for a heating element of an electronic cigarette, comprising:
A: coiling a heating wire made from metal material into a heating coil, and dividing the heating coil into sections; wherein the sections include a plurality of heating sections configured to atomize tobacco tar, and a plurality of connecting sections configured to be connected to a power source of the electronic cigarette; the plurality of heating sections are separated from each other with internals therebetween, and are further connected to each other through the plurality of connecting sections;
B: providing a deposition preventing layer on an external surface of each heating section to prevent the external surface of the heating section from being electroplated due to maloperation;
C: electroplating the heating coil, and at the same time coating outer peripheral faces of all of the connecting sections of the heating coil with coatings having an electrical resistivity lower than that of the heating wire;
D: removing the deposition preventing layer on the external surface of the heating section; and
E: cutting the heating coil electroplated, and obtaining a heating element cell during each cutting; wherein the heating element cell includes one heating element and two connecting sections arranged at both ends of the heating section.

2. The forming method of claim 1, wherein the step B specifically includes the step: painting a layer of deposition preventing paint on the external surface of the heating section to form the deposition preventing layer;
and the step D specifically includes the step: peeling off the deposition preventing paint.

3. The forming method of claim 1, wherein the step B specifically includes the step: wrapping a layer of rubber on the external surface of the heating section by a wire and cable extruder to form the deposition preventing layer;
and the step D specifically includes the step: removing the rubber by a cable peeling machine.

4. The forming method of claim 1, wherein the step B specifically includes the step: clamping and sealing up the external surface of the heating section by a clamp to form the deposition preventing layer;
and the step D specifically includes the step: removing the clamp from the external surface of the heating section.

5. The forming method of claim 2, wherein the methods for painting a layer of the deposition preventing paint on the external surface of the heating section include brushing, spraying, roller coating or dip coating.

6. The forming method of claim 2, wherein the deposition preventing paint is made from resins, or a mixture of polymers, additives and solvents.

7. The forming method of claim 6, wherein the step B specifically includes the step: twining the heating coil on an insulating square frame in such a way that the plurality of heating sections and connecting sections are located on different surfaces of the square frame respectively;
uniformly sealing up and blocking the surfaces of the square frame on which the heating sections located by a pressing plate or a clamp to form the deposition preventing layer;
and the step D specifically includes the step:
removing the pressing plate or the clamp.

8. The forming method of claim 1, wherein the metal material includes any one of nickel-chrome alloy, nickel-chrome-iron alloy, nickel-chrome-aluminum alloy and constantan alloy.

9. The forming method of claim 1, wherein the coatings are the coatings made of materials selecting from one or more of gold, silver, copper, zinc and tin.

10. The forming method of claim 1, wherein the electrical resistivity of the coatings is less than 2.5×10⁻⁸ Ωm.

11. A manufacturing method for an atomization assembly, the atomization assembly comprising a heating element configured to atomize tobacco tar, and a tar guiding wick configured to guide tobacco tar to the heating element for atomization; wherein the manufacturing method comprises the following steps:
S1: coiling a heating wire made from metal material into a heating coil, and dividing the heating coil into sections; wherein the sections include a plurality of heating sections configured to atomize tobacco tar, and a plurality of connecting sections configured to be connected to a power source of the electronic cigarette; the plurality of heating sections are separated from each other with internals therebetween, and are further connected to each other through the plurality of connecting sections;
S2: electroplating the heating coil, and simultaneously coating outer peripheral faces of all the connecting sections of the heating coil with coatings having an electrical resistivity lower than that of the heating wire;
S3: coiling the heating sections at a free end of the heating coil coated with the coatings on a tar guiding wick, in such a way that the heating sections are spirally twined on the tar guiding wick;
S4: cutting the connecting sections at one end of the heating sections twined on the tar guiding wick, in such a way that two ends of each heating section twined on the tar guiding wick are both connected to the connecting sections.

12. The manufacturing method of claim 11, wherein the step S3 specifically includes the step:
the tar guiding wick is a tar guiding wick coil which is sleeved at a first fixing part of a first bracket; wherein the first fixing part is rotatable relative to the first bracket under an action of an external force, and a free end of the tar guiding wick moves towards a first preset direction under an applied force of a traction device, in such a way that the heating section twined on the tar guiding wick moves towards the first preset direction along with the tar guiding wick;
after the step S4, a step is further included:
cutting the tar guiding wick at a first preset position in the first preset direction, in such a way that the heating section located at the end of the tar guiding wick falls down together with the tar guiding wick on which the heating section is twined, thereby forming the atomization assembly.

13. The manufacturing method of claim 12, wherein in the step S3, a first rotation device and a second rotation device are arranged between the first fixing part and the first preset position; a first tar guiding wick clamping assembly is arranged on the first rotation device, and a second tar guiding wick clamping assembly is arranged on the second rotation device; a heating wire clamping device is arranged at an end of the second rotation device oriented towards the first rotation device, in such a way that, after a connecting section at the free end of the heating coil has been clamped by the heating wire clamping device, the heating wire clamping device rotates along with the first rotation device and the second rotation device, and further moves in the first preset direction, in such a way that the heating section is spirally twined on the tar guiding wick.

14. The manufacturing method of claim 13, wherein in the step S3, a third tar guiding wick clamping assembly is arranged on one side of the first preset position opposite to the second rotation device, in such a way that when cutting the tar guiding wick, the tar guiding wick is clamped by the second tar guiding wick clamping assembly and the third tar guiding wick clamping assembly together; when the second tar guiding wick clamping assembly is released from the clamping on the tar guiding wick and moves along with the second rotation device in a direction opposite to the first preset direction, the third tar guiding wick clamping assembly clamps the free end of the tar guiding wick coil.

15. The manufacturing method of claim 14, wherein in the step S3, the first rotation device and the second rotation device are connected to a same power device by a transmission connection, in such a way that the first rotation device and the second rotation device are driven by the power device to rotate synchronously.

16. The manufacturing method of claim 15, wherein the traction device is a motor, and the motor is connected to the first rotation device and the second rotation device by a transmission connection; by driving the first rotation device and the second rotation device to move in the first preset direction, the tar guiding wick is conveyed towards the first preset direction.

17. The manufacturing method of claim 13, wherein a step S21 is further included between the steps S2 and S3:
sleeving the heating coil coated with coatings on a second fixing part of a second bracket, wherein the second fixing part is rotatable relative to the second bracket; the free end of the heating coil is conveyed towards a position between the first rotation device and the second rotation device by a second traction device.

18. The manufacturing method of claim 11, wherein a step is further included before the step S2: providing a deposition preventing layer on an external surface of the heating section to prevent the external surface of the heating section from being electroplated due to maloperation;
a step is further included after the step S2: removing the deposition preventing layer on the external surface of the heating section.

19. A manufacturing method for an atomization assembly, the atomization assembly comprising a heating element configured to atomize tobacco tar, and a tar guiding wick configured to transform tobacco tar to the heating element for atomization; wherein the manufacturing method comprises the following steps:
F1: coiling a heating wire made from metal material into a heating coil, and dividing the heating coil into sections; wherein the sections include a plurality of heating sections configured to atomize tobacco tar, and a plurality of connecting sections configured to be connected to a power source of the electronic cigarette; the plurality of heating sections are separated from each other with internals therebetween, and are further connected to each other through the plurality of connecting sections;
F2: electroplating the heating coil, and simultaneously coating outer peripheral faces of all the connecting sections of the heating coil with coatings having an electrical resistivity lower than that of the heating wire;
F3: cutting the heating coil electroplated, and obtaining a heating element cell during each cutting; wherein the heating element cell includes one heating element and two connecting sections arranged at both ends of the heating section;
F4: coiling the heating element cell on a tar guiding wick to make the heating section in a spiral shape;
F5: cutting the tar guiding wick coiled with the heating element cell to obtain a single atomization assembly.
